(19) United States
(12) Patent Application Publication
(10) Pub. No.: US 2017/0200519 A1
(43) Pub. Date: Jul. 13, 2017

(54) METHOD FOR THE DECONTAMINATION OF CONTAMINATED GRAPHITE

(71) Applicant: ALD VACUUM TECHNOLOGIES GMBH, Hanau (DE)

(72) Inventors: Johannes FACHINGER, Mönchengladbach (DE); Karl-Heinz GROSSE, Gründau (DE)

(21) Appl. No.: 15/326,834

(22) PCT Filed: Jun. 29, 2015
(86) PCT No.: PCT/EP2015/064747

§ 371 Date: Jan. 17, 2017

(30) Foreign Application Priority Data
Jul. 18, 2014 (DE) 10 2014 110 168.5

(51) Int. Cl. G21F 9/30; G21F 9/00

(52) U.S. Cl. CPC G21F 9/305; G21F 9/008

(57) ABSTRACT

The decontamination of contaminated graphite, in particularly of irradiated graphite. According to the present invention, this means a method of separating volatile radionuclides from contaminated graphite and transforming the graphite together with non-volatile radionuclides into a form which is suitable for final disposal. The method according to the present invention comprises the step of heating up the contaminated graphite for obtaining treated graphite, a step of compacting the treated graphite for obtaining a molded body and optionally a step of embedding the treated graphite in a matrix material for obtaining a sheathed molded body. The molded body comprising the treated graphite can be finally disposed and stored under low safety requirements depending on the country-specific requirements. So the volume of such material which requires a particularly laborious and thus particularly cost-intensive final disposal and storage, in particularly an underground storage in deep ground regions, can considerably be reduced. The last one also results in considerably reduced costs, when contaminated graphite which accrues every year in high amounts has to be disposed.

### FIELD OF THE INVENTION

The present invention relates to the decontamination of contaminated graphite, including irradiated graphite. According to the present invention, this is a method of separating volatile radionuclides from contaminated graphite together with the concurrent transformation of the graphite, including the non-volatile radionuclides, into a form which is suitable for final disposal.

### BACKGROUND OF THE INVENTION

Every year high amounts of contaminated, in particularly irradiated graphite accrue, especially in the case of the deconstruction of reactors (worldwide ca. 240 000 t of such graphite components exist).

Worldwide there is a plurality of different graphite-moderated nuclear reactors, such as for example UNGG in France, Magnox and AGR in England or RMBK in Russia. These reactors are normally cooled by gas and they use fuel elements which are encased by metal and which are packaged in so-called sleeves made of graphite, and in this condition they are moved through the reactor core. For this kind of reactors, normally, as a core material respective graphite blocks are used which serve as thermal insulation, as a moderator for collecting free neutrons and also as gas line elements. In the near future a lot of these plants have to be deconstructed, so that there is an urgent demand for a cost-effective and simple disposal strategy for contaminated, in particularly irradiated graphite. The placement of such components in deep geologic earth layers is extremely expensive. Till today nowhere in the world a simple near-surface final disposal of such components in containers filled with concrete has been approved, because the release of the radionuclides contained is not definitely excluded.

Normally, irradiated graphite may comprise different radionuclides, such as H-3, C-14, Co-60, CI-36, Cs-137, Sr-90. The content of such radionuclides, in particular, results from the neutron activation of nitrogen which is contained as an impurity in the graphite or in the cooling gas, but also from the neutron activation of the naturally occurring isotope C-13. To a greater or lesser extent, the radionuclides are distributed homogenously in the whole volume of the irradiated graphite. Due to this distribution of the radionuclides, also the whole volume of the irradiated graphite has to be classified as radioactive waste. Depending on country-specific classifications, the whole irradiated graphite even has to be classified partially as medium active waste.

The final disposal of contaminated, in particularly irradiated graphite in particularly becomes extremely complicated by radionuclides which are volatile and thus also mobile, in particular H-3, C-14 and CI-36. Volatile radionuclides which, in addition, are long-living ones, such as C-14 and CI-36, are a further problem. Volatile radionuclides may be present on the surface, in particular on the surfaces of the pore system of the irradiated graphite. There they may be chemically bonded, adsorbed or absorbed. Due to the content of such radionuclides a final disposal is more complicated. Due to the long half-life and the danger of a continuous release of such volatile radionuclides from the contaminated graphite, it has to be disposed under particular safety requirements in deep ground regions, and thus such a final disposal is connected with high effort and high costs.

For example, the content of C-14 of irradiated graphite from Spain precludes its final disposal in the near-surface final disposal zone El Cabril. According to the currently applicable formalities in the safety case for the near-surface final disposal in France only the concentration of radionuclides is considered. Even in the case, when a matrix material would guarantee a safe containment of the irradiated graphite, it is not allowed to take this fact into account in connection with the safety considerations. Thus, when such a graphite is safely embedded, due to its content of radionuclides a near-surface and space-saving as well as cost-effective final disposal is not allowed, wherein volatile radionuclides are contemplated in a particularly critical manner.

Imaginable and also known is, for example, the safe incorporation of contaminated, in particularly irradiated graphite in special matrix materials. In WO 2010/052321 A1 a matrix material for the final disposal of radioactive waste into which the radioactive waste is incorporated is described. In this case, the radioactive waste which may also be irradiated graphite is either mixed directly with the matrix material and optionally together with matrix material it is subjected to cold preforming at room temperature. Subsequently, the waste is incorporated into cavities of a preformed molded body made of matrix material and then it is subjected to final compression. In an alternative, the waste together with the matrix mixture can directly be subjected to final compression resulting in a final molded body. The final compression is conducted at increased temperatures and increased pressure. In particular due to the process conduct the temperatures of regions of the material which are close to the edges are higher than the temperatures of inner regions of the material. Thus, due to the process conduct volatile radionuclides of the waste become enriched in the inner regions of the package. In addition, the waste is embedded in the form as it is accrued without any possible prior treatment. Thus, the produced package contains the radionuclides of the waste, including volatile radionuclides, and thus it has to be disposed under respective strict safety requirements, in particular in deep ground regions.

In WO 2011/117354 A1 packages comprising an impermeable matrix of glass/graphite, briefly IGG, are described into which radioactive waste in metal-encased form can be embedded. With that a so-called inverse design is achieved. The metal casing surrounding the waste acts as a diffusion barrier and prevents the release of the radionuclides which are contained in the waste into the IGG. For the production of the waste elements the waste optionally together with a binder is filled into metal casings and subsequently in the metal casing it is extruded to composite-compressed rods. A prior treatment of the waste is not envisaged. So also after the embedment possible volatile radionuclides are still contained in the waste. Thus, as already mentioned above, depending on country-specific classifications a final disposal in deep ground regions is still necessary.

### SUMMARY OF THE INVENTION

Therefore it is an object of the present invention to provide a method which makes a simple and cost-effective removal and final disposal of contaminated, in particularly irradiated graphite under low safety requirements possible. For saving capacities of underground disposal sites, preferably, a near-surface final disposal and/or a final disposal at the surface should become admissible depending on country-specific regulations.

The object is solved by the method for the decontamination of contaminated graphite described herein. The method of the present invention comprises the following steps:
heating up of a base mixture comprising contaminated graphite and at least one glass for separating volatile radionuclides from the contaminated graphite, wherein a treated graphite is obtained;
compacting of the treated graphite for obtaining a molded body which is suitable for final disposal;
optionally embedding of the molded body in a matrix material for obtaining a sheathed molded body.

### DETAILED DESCRIPTION OF THE INVENTION

The step of heating up the base mixture for separating the volatile radionuclides is preferably conducted in the same device as the step of compacting so that no further handling of the graphite is required. So the method according to the present invention can be conducted still more cost-effective and faster.

The molded body prepared with the method according to the present invention is, according to the present invention, suitable for final disposal of the treated graphite, thus preferably for the safe storage over geologic periods of time, ideally of up to 1 million years or longer.

Preferably, the molded body can be disposed and stored under reduced safety requirements in comparison to the storage of contaminated graphite which has not been subjected to any decontamination according to the present invention. According to the safety requirements for final disposal a safe and near-surface final disposal and/or even a safe final disposal of the molded body which has been prepared according to the present invention at the surface are admissible. So the volume of such material which requires a particularly elaborate and thus particularly cost-intensive disposal and storage, in particularly an underground storage in deep ground regions, can considerably be reduced. The last one is particularly advantageous with respect to the highly limited storage capacities and the continuous accruement of large amounts of contaminated, in particularly irradiated graphite. Thus, in addition, the costs of a disposal of contaminated graphite can considerably be reduced.

“Contaminated graphite” is a graphite which contains proportions of radionuclides. Preferably, contaminated graphite is a graphite having an activity of >10³ Bq/g, in particularly ≧10⁴ Bq/g or even ≧10⁵ Bq/g. Thus, according to the present invention, the “contaminated graphite” is preferably at least a material with low-level activity being characterized by activity values in the mean range of the common range for “low-level activity”, in particularly even a material with medium-level activity.

As a result of a contamination it can be possible that the radionuclides have been migrated into the graphite, for example, when the graphite is a constituent of fuel elements. But the reason for the content of radionuclides can also be neutron activations, when graphite or impurities in the graphite are irradiated. Thus, according to the present invention, the term “contaminated graphite” also comprises an “irradiated graphite” which contains radionuclides due to said irradiation. Frequent radionuclides which can be present in the contaminated graphite comprise H-3, C-14, CI-36, Co-60, Cs-135, Cs-137, I-131, Sr-90, Pu-239, U-235 and other radioactive isotopes of uranium, Th-232 and other radioactive isotopes of thorium, Pb-203 and other radioactive isotopes of lead and mixtures thereof.

The method according to the present invention is suitable for a contaminated graphite which at least comprises one volatile radionuclide. Thus, a “contaminated graphite” according to the present invention comprises at least one volatile radionuclide.

According to the present invention, volatile radionuclides are radionuclides which under standard conditions according to DIN 1343 (issue date: January 1990) or under conditions of heating up the contaminated graphite to at least 350° C. and at most 1600° C. at a pressure of lower than 15 MPa, preferably lower than 10 MPa, further preferably lower than 5 MPa are in the gaseous state or in the form of gaseous chemical compounds or can be transformed under the mentioned conditions into the gaseous state or gaseous compounds. Gaseous compounds of the radionuclides are in particularly compounds of the radionuclide in elemental form and/or in the form of oxides or halides of the radionuclide. In any case, volatile radionuclides are H-3, C-14, CI-36, I-131, Cs-135 and Cs-137. Thus, the contaminated graphite comprises preferably at least one volatile radionuclide being selected from the group consisting of H-3, C-14, CI-36, I-131, Cs-135 and Cs-137. One of the mentioned volatile radionuclides may be present in the contaminated graphite. Imaginable is also the presence of mixtures comprising at least two or more of the mentioned volatile radionuclides in the contaminated graphite.

With the method according to the present invention in particularly radionuclides which are selected from H-3, C-14 and CI-36 can be separated from the contaminated graphite in a particularly advantageous manner. Therefore, the method according to the present invention is particularly suitable for the decontamination of a contaminated graphite which comprises at least one volatile radionuclide being selected from the group consisting of H-3, C-14, CI-36 and mixtures thereof.

Preferably, the contaminated graphite is a graphite which has a total activity of volatile radionuclides of >10⁻¹ Bq/g, further preferably >10¹ Bq/g, still more preferably >10² Bq/g and in particularly >10³ Bq/g. In embodiments the total activity of volatile radionuclides in the contaminated graphite is >10⁵ Bq/g as well as in particularly >10⁶ Bq/g. Namely, the method according to the present invention is in particularly suitable for contaminated graphite which comparatively has medium or high total activities of volatile radionuclides. Since the method according to the present invention allows the separation of the volatile radionuclides, so a particularly effective and cost-saving disposal of the contaminated graphite becomes possible.

In embodiments in which CI-36 is contained in the contaminated graphite the activity of this radionuclide is in particularly preferably >10⁻¹ Bq/g, in particularly >10¹ Bq/g and preferably >10³ Bq/g. In embodiments in which the contaminated graphite comprises C-14 the activity of C-14 should preferably be at least >10² Bq/g, in particularly >10⁴ Bq/g and preferably >10⁶ Bq/g. When the contaminated graphite comprises H-3, then the activity of H-3 in the contaminated graphite is preferably >10³ Bq/g, further preferably >10⁵ Bq/g and still more preferably >10⁷ Bq/g. When the activities are higher than the mentioned preferred lowest activities, then the advantages of the method according to the present invention particularly come into effect.

Besides the at least one volatile radionuclide the contaminated graphite may comprise further radionuclides which are non-volatile. Such radionuclides in particularly comprise Co-60, Sr-90, Pu-239, U-235 and other radioactive isotopes of uranium, Th-232 and other radioactive isotopes of thorium, Pb-203 and other radioactive isotopes of lead and mixtures thereof. In this non-exhaustive enumeration only examples are listed. Besides the at least one volatile radionuclide in the contaminated graphite optional other radionuclides may be present which are not explicitly mentioned here.

Besides graphite and the at least one volatile radionuclide the contaminated graphite may contain further constituents which have been added to the graphite according to its use or which are contained as impurities. The contaminated graphite preferably originates from fuel element balls and/or reflector blocks and/or the reactor core. This is a non-exhaustive enumeration. In particularly, the contaminated graphite may also originate from thermal columns of research institutions and sleeves from Magnox and UNGG reactors.

According to the present invention, a “base mixture” is a mixture which comprises the contaminated graphite and at least one glass. Besides the contaminated graphite and the glass the base mixture may contain further components. Optionally, at least one oxidant may be contained. Particularly preferably, the base mixture consists of the contaminated graphite and the glass as well as also the optional oxidant. Preferably, the base mixture can be obtained by mixing the constituents contained therein, in particularly the contaminated graphite and the glass and the oxidant. Preferably, the base mixture is a homogenous mixture, i.e. the constituents are uniformly distributed in the base mixture. A person skilled in the art knows suitable methods of mixing. Preferably, the base mixture is in the form of a powder, wherein the mean grain diameters of the constituents contained therein are preferably lower than 100 μm. When in this invention a mean grain diameter is mentioned, then always the diameter according to Ferret is meant.

According to the present invention, the term “treated graphite” describes the product which is obtained by the step of heating up the base mixture according to the present invention.

The “treated graphite” comprises the constituents of the base mixture, but preferably it is characterized by a considerably reduced content of volatile radionuclides. According to the present invention, the treated graphite is further processed by compaction to a molded body which is suitable for final disposal.

Thus, the treated graphite is preferably a graphite which is characterized by a considerably reduced content of volatile radionuclides. According to the present invention, a “considerably reduced content” of volatile radionuclides means that in the treated graphite the content of at least one volatile radionuclide of the radionuclides which are contained in the contaminated graphite is reduced in an extent of at least 60%, preferably at least 70%, further preferably at least 80% and still more preferably at least 90%, based on the amount of said volatile radionuclide in the contaminated graphite.

Particularly preferably, in the treated graphite only at most 50%, preferably at most 40% and still more preferably less than 30% of the volatile radionuclides, based on the total amount of volatile radionuclides in the contaminated graphite, are present. Still more preferably, in the treated graphite only less than 25%, preferably even less than 15% of the volatile radionuclides, based on the total amount of volatile radionuclides in the contaminated graphite, are present. The detection and the determination of the amount of the volatile radionuclides are achieved according to methods which are known by a person skilled in the art. A person skilled in the art knows which suitable detection option can be chosen for each radionuclide. In particular, as methods for the selective and quantitative determination of volatile radionuclides the liquid scintillation spectrometry, the total alpha/beta activity measurement, mass spectrometry, a neutron activation analysis and optionally a radiochemical separation are available.

When the contaminated graphite comprises H-3, then the treated graphite is preferably a graphite which contains at most only 25%, further preferably at most only 15% and particularly preferably less than 5% as well as especially preferably less than 2% of H-3, based on the amount of H-3 in the contaminated graphite. When the contaminated graphite comprises C-14, then the treated graphite is preferably a graphite which contains less than 65%, further preferably less than 55% and still more preferably less than 50% of C-14, based on the amount of C-14 in the contaminated graphite. When the contaminated graphite comprises CI-36, then the treated graphite is preferably a graphite which contains less than 80%, further preferably less than 60% and still more preferably less than 50% of CI-36, based on the amount of CI-36 in the contaminated graphite.

When in the contaminated graphite H-3 is contained, then the treated graphite is preferably a graphite with an activity of H-3 of <10³ Bq/g, further preferably <10² Bq/g, and it is particularly preferable, when in the treated graphite H-3 cannot be detected with common detection methods. When in the contaminated graphite C-14 is contained, then the activity of C-14 in the treated graphite is preferably <10² Bq/g, further preferably <10¹ Bq/g. When the contaminated graphite comprises CI-36, then the activity of CI-36 in the treated graphite is preferably only <10⁻¹ Bq/g. Depending on the country-specific classification, the graphite treated according to the present invention may be classified as a material which is no longer radioactive, thus as a material which according to a special measurement is free of radioactivity, or as a material with only low-level activity. This is also true for the molded body which, according to the present invention, is obtained by compaction of the base mixture. Thus, depending on the country-specific classification, the molded body according to the present invention may be classified as a material which is no longer radioactive, thus as a material which according to a special measurement is free of radioactivity, or as a material with only low-level activity. In particularly, the molded body is preferably characterized by a considerably reduced content of volatile radionuclides.

According to the present invention, the step of heating up the base mixture is conducted for separating the volatile radionuclides from the contaminated graphite, wherein preferably during the step of heating up the base mixture the volatile radionuclides are separated from the contaminated graphite. The radionuclides are preferably “separated” from the contaminated graphite, when a treated graphite having a considerably reduced content of volatile radionuclides is obtained. This is in particularly guaranteed by the composition of the base mixture according to the present invention and by the method conduct according to the present invention.

The separation of the volatile radionuclides can be intensified by the addition of oxidants. Due to their oxidative effect they support the release of volatile radionuclides from the contaminated graphite. In particularly, such substances may support the opening of closed pores in which volatile radionuclides are enclosed and/or trigger the reaction of chemically bonded radionuclides under the process conditions to gaseous compounds.

In preferable embodiments no oxidants are used, thus no oxidants are added to the base mixture. Surprisingly, the glass in the base mixture already shows an optimum oxidative effect so that the method according to the present invention can be designed still more cost-effective and uncomplicated. In alternative embodiments in which oxidants are added to the base mixture the content of these substances should not exceed values of preferably at most 8% by weight and further preferably at most 5% by weight as well as still more preferably at most 2% by weight, based on the total weight of the base mixture. When an amount of oxidants is used which is too high, then the material of the facilities used is attacked which results in reduced lifetime of the facilities. Oxidants which are preferably used are organic peroxides.

In the base mixture the contaminated graphite is preferably present in the form of a graphite powder, wherein preferably the contaminated graphite is characterized by a mean grain diameter of less than 100 μm, further preferably at most 50 μm and particularly preferably at most 30 μm. When the contaminated graphite is not already characterized by such grain diameters, then the contaminated graphite is comminuted before the step of heating up. Comminution methods are well-known for a person skilled in the art. The densities of the treated graphite and/or the molded body which can be obtained can become higher and the separation of the volatile radionuclides from the contaminated graphite can become better as the grain diameter of the graphite powder becomes smaller. Thus before the step of heating up the contaminated graphite, optionally, a step of comminuting the contaminated graphite is conducted.

Besides a binding effect and a certain oxidative effect the glass in the base mixture in particularly has also a structure-imparting function and it supports the production of a particularly dense and pore-free treated graphite and/or of the molded body which can be obtained by compaction. Glass is characterized by the advantage that during the step of heating up the base mixture no gaseous cracking products which might result in the formation of pores in the treated graphite are produced. This means that the glass is only hardly or even not the subject of reaction processes. Thus, also due to the method conduct according to the present invention, the formation of pores is effectively prevented. The glass in the softened and/or molten state suffuses the contaminated graphite and optionally the further constituents of the base mixture so that the voids between the particles can be closed by capillary and/or adhesion forces and after the step of compacting the base mixture a dense and nearly pore-free molded body which is sufficiently stable for further processing can be obtained.

The method according to the present invention allows the production of a molded body which is preferably substantially pore-free, namely has a density of preferably at least 90%, further preferably at least 95%, still further preferably at least 98%, still more preferably even in the range of >99% and especially preferably in the range of >99.5% of the theoretical density. It is advantageous, when the molded body has a high density, so that the risk of the penetration of humidity into the molded body is further reduced and optional non-volatile radionuclides from the contaminated graphite are enclosed in a particularly effective manner. So also the release of these radionuclides into an optional matrix material in which the molded body can be embedded can be prevented in an even better way. Due to the structure-imparting effect of the glass, preferably, the molded body has in addition a good hardness.

According to the present invention it is preferred, when the glass of the base mixture is selected from borosilicate glasses, aluminophosphate glasses, lead glasses, phosphate glasses, alkali glasses, alkaline earth metal glasses and mixtures thereof. It is particularly preferred, when the glass of the base mixture is selected from borosilicate glasses, aluminophosphate glasses, lead glasses and mixtures thereof. It is especially preferred, when the glass of the base mixture is a borosilicate glass.

The advantage of borosilicate glasses is good corrosion stability. In addition, borosilicate glasses are glasses with high chemical and temperature resistance. The good chemical resistance, for example with respect to water and a lot of chemicals, can be explained by the content of boron in the glasses. The temperature resistance and the insensitiveness of the borosilicate glasses with respect to abrupt temperature fluctuations are a result of the low coefficient of thermal expansion of borosilicate glass of about 3.3×10⁻⁶ K⁻¹. At the date of the application usual borosilicate glasses are for example Jenaer Glas, Duran®, Pyrex®, Ilmabor®, Simax®, Solidex® and Fiolax®.

A person skilled in the art knows a typical composition of borosilicate glasses, and in the following an example thereof is given in percent by weight:
70% to 80% SiO₂
7% to 13% B₂O₃
4% to 8% alkali metal oxides, such as Na₂O or K₂O
2% to 7% (Al₂O)
0% to 5% alkaline earth metal oxides, such as CaO, MgO.

The advantage of aluminophosphate glasses is also their high radiation resistance as well as their resistance with respect to high temperatures and water.

Lead glasses, on the other hand, are suitable due to their possible absorption of ionic radiation. Phosphate glasses are characterized by low melting points so that their use is also advantageous. As a result, lower temperatures can be used in the step of heating up the base mixture so that the method in total can be designed in a cost- and energy-saving manner.

Alkali glasses are characterized by low viscosities. As a result thereof, the ability of suffusing the contaminated graphite is promoted. So pores can easily be closed and preferably a high density of the treated graphite can be achieved.

Alkaline earth metal glasses, on the other hand, show increased acid stability, can be processed easily and are cost-efficient so that they can also be used according to the present invention.

Preferably, the glass is used in the base mixture in the form of a powder so that an optimum binding effect and an optimum structure-imparting effect can be achieved. Preferably, the mean grain diameter of the glass powder is lower than 100 μm, further preferably at most 50 μm and particularly preferably at most 30 μm. The glass can close optional pores between the other constituents of the base mixture more easily as the grain diameter decreases.

It is advantageous, when the base mixture contains at least 5% by weight of glass, and it is further preferred, when the base mixture contains at least 7% by weight, still further preferably at least 10% by weight and particularly preferably at least 12% by weight of glass, based on the total amount of the base mixture. When the amount of the glass used is too low, then often a sufficient binding and structure-imparting effect cannot be achieved. Preferably, the base mixture comprises up to 30% by weight, further preferably up to 20% by weight and particularly preferably up to 18% by weight of glass. When the amount of the glass used in the base mixture is too high, then it is not possible to incorporate sufficient contaminated graphite. Then the molded bodies according to the present invention are no longer suitable for a space-saving final disposal, since as a result per area less contaminated graphite has been processed. Thus, on the one hand, the amount of glass should be sufficiently high, but, on the other hand, in the base mixture also an amount of glass should be used which is as low as possible, so that an amount of contaminated graphite which is as high as possible is incorporated in the method according to the present invention.

In the step of heating up the base mixture, i.e. during the heat treatment of the base mixture, the base mixture is preferably heated up to a target temperature of at least 650° C., further preferably at least 700° C. and still more preferably at least 800° C. and especially preferably at least 1000° C. When the target temperature to which the base mixture is heated up is too low, then the glass is not sufficiently softened for penetrating between the pores of the further constituents of the base mixture. At temperatures which are too low, also the volatile radionuclides often can only be separated from the contaminated graphite in an insufficient manner. Namely, in particularly, it may also be required to cleave bonds in the graphite for releasing volatile radionuclides. The target temperature of the base mixture should preferably be not higher than 1600° C., preferably at most 1500° C., still more preferably at most 1400° C. and still more preferably at most 1350° C. as well as particularly preferably at most 1200° C. When the target temperature is too high, then the method in total becomes too expensive and there is the risk of undesirable reactions in the base mixture. Target temperatures of between 700° C. and 1300° C., in particularly between 750° C. and 1250° C. and still more preferably between 800° C. and 1200° C. have shown to be particularly suitable. At these temperatures the binding and structure-imparting effects of the glass were particularly distinctive and it was possible to separate the volatile radionuclides in a particularly advantageous manner.

Preferably, the step of heating up the base mixture at first comprises a step of heating up to an intermediate temperature which is lower than the target temperature, before the base mixture is heated up to the target temperature. Thus, preferably, the step of heating up the base mixture to the target temperature is at least a two-phase step. In this case, according to the present invention, the “phase of heating up” is the targeted heating up to a certain set temperature which subsequently can be maintained for a predetermined period of time, preferably at least 5 min, further preferably at least 10 min.

It is particularly preferred, when the step of heating up is a two-phase step, wherein the first phase of heating up comprises the achievement of an “intermediate temperature” and the second phase of heating up comprises the further heating up starting from the intermediate temperature for achieving the “target temperature”. Such a temperature management has been shown to be particularly advantageous and it allowed a particularly effective separation of volatile radionuclides as well as a cost-effective and quick method design in total. It is particularly preferred, when the content of volatile radionuclides is already considerably reduced in the first phase of heating up so that already after the first phase of heating up a treated graphite can be obtained. Then, the second phase of heating up serves for the separation of optional still remained volatile radionuclides together with concurrent optimum softening of the glass of the base mixture. Preferably, the intermediate temperature is at least 350° C., further preferably at least 400° C., still more preferably at least 420° C. When the intermediate temperature of the base mixture is too low, then there is the risk that volatile radionuclides cannot be sufficiently removed in the first phase of heating up. Particularly preferably, the intermediate temperature is between 400° C. and 500° C., further preferably between 420° C. and 480° C., in particularly 450° C.±20° C.

The pressing pressure during the step of heating up the base mixture is preferably lower than 15 MPa, further preferably lower than 12 MPa and particularly preferably lower than 10 MPa.

When the step of heating up is a two-phase step, which is particularly preferable according to the present invention, then the pressing pressure during the first phase of heating up is preferably lower than 5 MPa, further preferably lower than 3 MPa, still more preferably lower than 2 MPa and particularly preferably lower than 0.5 MPa as well as still more preferably lower than 0.2 MPa as well as especially preferably normal pressure, thus about 0.101325 MPa+/−20%. According to the present invention, the step of heating up to the intermediate temperature is preferably conducted without any pressure from outside. Preferably, the second phase of the step of heating up is conducted at a pressing pressure of lower than 15 MPa, further preferably lower than 12 MPa and still more preferably lower than 10 MPa. It is especially preferred, when the pressing pressure during the second phase of heating up is between 5 MPa and 10 MPa, further preferably between 6.5 and 9.5 MPa and particularly preferably between 7.5 and 8.5 MPa. Such a pressing pressure was shown to be particularly advantageous for separating volatile radionuclides which are still present together with concurrent optimum softening of the glass constituent.

When during the step of heating up the base mixture a pressing pressure is applied which is too high, thus when at the same time the base mixture is heated up and compacted, then there is the risk that due to the heating up from outside together with the concurrent application of pressure this results in an accumulation of volatile radionuclides in the center of the base mixture and that so the volatile radionuclides cannot be separated from the contaminated graphite. Such a heating up from outside together with the concurrent application of an increased pressure corresponds to the common method conduct for the production of an IGG matrix such as described in WO 2011/117354 A1. Due to the considerable content of volatile radionuclides, a resulting package cannot be disposed under reduced safety requirements, in particularly not in a near-surface disposal site. It goes without saying that, according to the present invention, before the step of heating up the base mixture no compaction takes place. A step of compaction before the step of heating up the base mixture may also result in a much more difficult separation of volatile radionuclides and in an accumulation of radionuclides inside the base mixture which is not desirable.

The heating rate during the step of heating up is preferably at least 5° C./min, preferably at least 8° C./min and further preferably at least 10° C./min. Such a slow step of heating up facilitates the separation of radionuclides from the contaminated graphite. The heating rate during the step of heating up should not be too high, thus preferably lower than 300° C/min, further preferably lower than 100° C./min. When the heating rates are too high, then the method in total becomes too expensive and too laborious. Heating rates of between 15° C./min and 20° C./min have been shown to be particularly advantageous, in particular during the second phase of heating up.

The duration of the step of heating up, thus of the heating till a target temperature of preferably at least 650° C. and preferably at most 1600° C. is achieved, is preferably at least 5 minutes, further preferably at least 10 minutes and particularly preferably at least 12 minutes as well as still more preferably at least 18 minutes and still more preferably at least 25 minutes. When the step of heating up is conducted to fast, thus when the duration of the step of heating up is too short, then there is the risk that it is not possible to sufficiently separate the volatile radionuclides from the contaminated graphite. However, preferably, the duration of the step of heating up is at most 60 hours, preferably at most 50 hours and still more preferably at most 24 hours, particularly preferably at most 10 hours. When the duration of the step of heating up is too long, then there is the risk that side reactions in the base mixture may take place.

A target temperature of the base mixture of preferably at least 650° C. and preferably at most 1600° C. is preferably maintained over a period of time of at least 5 minutes, further preferably at least 10 minutes and particularly preferably at least 12 minutes. When such a target temperature is only maintained over a period of time which is too short, then there may be the risk that optionally still present volatile radionuclides are not sufficiently separated from the contaminated graphite. Preferably, the target temperature is maintained over a period of time of at most 15 hours, further preferably at most 10 hours. When the step of heating up is a two-phase step, which is preferable, then the intermediate temperature is preferably maintained over a period of time of at least 5 minutes, further preferably at least 10 minutes and particularly preferably at least 12 minutes. The intermediate temperature may be maintained over a period of time of up to 30 hours, preferably up to 26 hours and further preferably up to 24 hours. When the intermediate temperature is maintained over a period of time which is too short, then there is the risk that the volatile radionuclides are not sufficiently separated, because especially in the first phase of heating up, according to the present invention, already a considerable reduction of the volatile radionuclides can be achieved.

The glass viscosity during the step of heating up to the target temperature, preferably in the second phase of heating up, is preferably ≦10⁵ dPa×s, further preferably <10⁵ dPa×s. When the viscosity of the glass during the step of heating up is too high, then the glass cannot sufficiently penetrate between the pores of the further constituents of the base mixture so that on a regular basis no molded body which is sufficiently dense and hard can be achieved.

The release of volatile radionuclides is preferably monitored during the step of heating up, preferably via an online measurement. Particularly preferably, the period of time of the step of heating up and/or the period of the time of maintaining a special temperature, preferably the intermediate temperature and the target temperature, are adjusted so that a treated graphite with a considerably reduced content of volatile radionuclides remains.

The step of heating up is particularly preferably conducted in vacuum, wherein the pressure of the remaining gas is preferably <10⁻³ MPa, further preferably ≦10⁻⁴ MPa. The step of heating up may be conducted by the addition of heat, current input, microwaves or other methods for heating a material.

It is preferable according to the present invention, when the step of heating up is conducted such that a temperature gradient between the innermost regions of the base mixture and the regions of the base mixture which are close to the edges is achieved. In this case the innermost regions of the base mixture are characterized by higher temperatures than the regions of the base mixture which are close to the edges, which according to the present invention is called “negative temperature gradient”, so that it can be distinguished from the normal temperature distribution with a higher temperature in the regions which are close to the edges. According to the present invention, a negative temperature gradient is in particularly guaranteed by the selection of a suitable heating rate and a suitable period of time of the step of heating up and/or a suitable period of time of maintaining the target temperature and the preferred intermediate temperature. A negative temperature gradient according to the present invention results in such transport processes of the volatile radionuclides that an even better separation of the volatile radionuclides becomes possible.

According to the present invention, a negative temperature gradient in the base mixture is present, when the lowest temperature difference measured (ΔT) between a central measuring point and at least 2 external measuring points, preferably at least 3 external measuring points, along a horizontal plane within the base mixture is preferably such that the value of the temperature at the central measuring point is more than 5° C., further preferably more than 10° C. and particularly preferably more than 20° C. as well as still more preferably more than 50° C. higher than the value of the temperature at the external measuring points. But this temperature difference should not be too high, because then the method in total would become too cost-intensive and too laborious. Thus, ΔT should be at most 300° C., further preferably at most 200° C. In this case the horizontal plane within the base mixture is selected such that it divides the base mixture in the horizontal direction in two equal halves based on the volume of the base mixture. The central measuring point and the external measuring points are along this horizontal plane.

In this case the “central measuring point” is located at the site of the horizontal plane at which the horizontal plane crosses a vertical plane which for its part separates the base mixture in a vertical direction in two equal halves based on the volume of the base mixture. The external measuring points are located at the horizontal plane in such a manner that the smallest distance between the central measuring point and each of the external measuring points is at least 60%, preferably at least 70% and still more preferably at least 80% of the length of a straight line from the central measuring point to the edge of the base mixture, wherein the straight line is oriented such that it crosses the external measuring point and the central measuring point and that it runs from edge to edge of the base mixture. So it is guaranteed that the locations of the external measuring points are sufficiently far away from the central measuring point and sufficiently near to the edge of the base mixture.

The highest distance between each external measuring point and the central measuring point is selected such that the distance is at most 95% and preferably at most 90% of the length of the straight line from the central measuring point to the edge of the base mixture. So it is guaranteed that the locations of the external measuring points are not too near to the edge of the base mixture. So the temperature profile in the base mixture can be represented in an ideal way.

After the step of heating up the base mixture, according to the present invention, a step of compacting the treated graphite, i.e. a step of exerting an increased pressing pressure, follows. According to the present invention, this means the exertion of a pressing pressure of preferably at least 20 MPa. So a particularly stable and dense treated graphite can be achieved, which can easily be processed in the method according to the present invention. Preferably, the step of compacting is conducted at an increased temperature, preferably at the target temperature, thus at temperatures of between 650° C. and 1600° C., further preferably at temperatures of between 700° C. and 1400° C. and still more preferably at temperatures of between 800° C. and 1200° C.

The pressing pressure during the step of compacting is preferably up to 250 MPa, further preferably up to 200 MPa, still further preferably up to 180 MPa and still more preferably up to 150 MPa. The pressure should not be too high, since then the method in total becomes too expensive and too laborious. But the pressing pressure during the step of compacting should be at least 20 MPa, preferably at least 30 MPa and still more preferably at least 50 MPa and further preferably at least 60 MPa. In cases with a pressing pressure in this range a particularly advantageous compaction of the treated graphite was achieved. Preferably, the step of compacting is conducted under a protective gas. In an alternative the step of compacting is conducted under vacuum, wherein the pressure of the remaining gas is preferably <10⁻³ MPa, further preferably ≦10⁻⁴ MPa.

The step of compacting is preferably conducted in a hot isostatic press, a hot vacuum press or a spark plasma sintering plant (SPS). Preferably, also the step of heating up the base mixture is already conducted in one of the mentioned facilities, preferably in the same facility as the step of compacting.

The pressing force in the SPS is preferably between 80 kN and 500 kN, particularly preferably between 90 kN and 300 kN for guaranteeing a sufficient compaction. According to the present invention, the pressure of the remaining gas in the SPS is preferably at most 10⁻³ MPa, wherein the pressure of the remaining gas is particularly preferably lower than 10⁻³ MPa. Preferably, the treated graphite is filled into an axial pressing mold. Preferably, already before in the pressing mold the step of heating up the base mixture according to the present invention is conducted. In this case the treated graphite is already present in the axial pressing mold.

In this facility the step of heating up the base mixture can be conducted by applying electricity, in particularly a direct current, with current strengths in the range of 3 kA to 8 kA, preferably 3.5 kA to 5 kA and still more preferably 4 kA to 4.5 kA and voltages of 4 V to 10 V, preferably 4.5 V to 8 V, still more preferably 5 V to 6 V. The power input should be 15 kW to 30 kW, in particularly 20 kW to 25 kW. For heating up the base mixture, in this case, the base mixture is directly used as an electric conductor for the direct current. In the step of compacting, preferably, a pressing pressure of 50 MPa to 250 MPa is applied under a protective gas or under vacuum. The method facilitates the production of a molded body with high density already in short process times.

In a further embodiment hot isostatic pressing is used for compacting. In this case the treated graphite is filled into a container. Preferably, also the step of heating up the base mixture is conducted in this container. Preferably, the step of compacting is conducted at a pressing pressure of between 20 MPa and 200 MPa, preferably under vacuum.

The pressing pressure of preferably between 20 MPa and 250 MPa can be maintained over a period of time of up to 15 hours, preferably up to 12 hours and ideally up to 10 hours. When the pressing pressure is maintained for a period of time which is too long, then the method in total becomes too expensive and too laborious. According to the present invention, the step of compacting, preferably, also comprises the cooling of the obtained molded body. Preferably, at first a first step of cooling the molded body to temperatures of lower than 800° C., preferably lower than 600° C., further preferably 500° C.±5° C. under maintaining the pressing pressure at a value of preferably between 20 MPa and 250 MPa is conducted. The first cooling is preferably conducted over a period of time of at least 1 min, further preferably 2 min. This period of time is at most 120 min, further preferably at most 60 min. A period of time for the first cooling step of 5 minutes has been shown to be particularly suitable. After this first step of cooling the glass viscosity should be at least 10⁶ dPa×s, preferably ≧10⁶ dPa×s. Preferably, a second step of cooling to temperatures of lower than 35° C., further preferably lower than 30° C. and still more preferably 25° C.±5° C. under concurrent pressure reduction follows.

It is a particular advantage of the method according to the present invention that for a safe final disposal an embedment and/or incorporation of the molded body in further materials or metal containers is not required. In fact, the molded body prepared according to the present invention is suitable for final disposal, thus preferably for a safe storage over geologic period of times of ideally up to 1 million years or longer. But, in addition, the molded body can also be embedded in a matrix material.

Therefore, in embodiments of the method according to the present invention the molded body is embedded in a matrix material. So it is possible to further improve the capability of the molded body for final disposal and to enclose the treated graphite in a safer manner. In particular, such an embedment of the molded body imparts additional irradiation and corrosion stability. The molded body can be embedded in the matrix material without any further intermediate steps, such as a further step of treating or processing, which are not described here. According to the present invention, in particular, before the embedment in the matrix material it is not required that the molded body is placed in an additional metal casing which may act for example as a diffusion barrier. In contrast, the molded body is preferably embedded in the matrix material without any outer metal casing. This is advantageous, because so a cost-effective storage and a simple method conduct become possible. And it is also true that a metal casing only temporarily offers sufficient protection against diffusion due to possible corrosion and crack formation, when it is used for a longer storage time. With the method according to the present invention a diffusion of radionuclides from the contaminated graphite into the matrix material is already sufficiently prevented and/or reduced by the composition of the base mixture according to the present invention and by the method conduct according to the present invention, in particular by the step of heating up the base mixture for separating volatile radionuclides from the contaminated graphite. Therefore, according to the present invention, before the embedment in the matrix material an additional incorporation of the molded body into a metallic casing is not required.

“Embedding” according to the present invention means that the molded body is enveloped in the matrix material, wherein according to the present invention this is called “sheathed molded body”. The molded body is enveloped in the matrix material, when more than 95%, preferably more than 98% of the exterior surface of the molded body are covered by the matrix material, and especially preferably when the exterior surface of the molded body is completely covered with the matrix material.

According to the present invention, the matrix material comprises as matrix constituents graphite which is not contaminated and at least one inorganic binder which is selected from glasses, aluminosilicates, silicates, borates and mixtures thereof. Such matrix materials are known from prior art.

Preferably, the inorganic binder is selected from glasses, wherein in this case a so-called impermeable graphite/glass matrix, briefly IGG, is meant. Glass as an inorganic binder has the advantage that no gaseous cracking products which result in the formation of pores in the matrix material are produced. In addition, it suffuses in the softened and/or molten state the residual matrix constituents, and the voids between the particles are closed by capillary and/or adhesion forces. So a high density of the matrix material and a superior corrosion resistance are guaranteed.

According to the present invention it is preferred, when the glass in the matrix material is selected from borosilicate glasses, aluminophosphate glasses, lead glasses, phosphate glasses, alkali glasses, alkaline earth metal glasses and mixtures thereof. A person skilled in the art will select a suitable glass according to her or his expert knowledge. It is particularly preferred, when the glass is selected from borosilicate glasses, aluminophosphate glasses, lead glasses and mixtures thereof. Due to the high corrosion stability as well as the high chemical and temperature resistance it is especially preferred, when the glass is a borosilicate glass.

The proportion of graphite of the matrix material is preferably at least 60% by weight, further preferably at least 65% by weight. The proportion of graphite is preferably at most 90% by weight. The proportion of inorganic binder is preferably at least 10% by weight. Preferably, a maximum content of 40% by weight of inorganic binder is contained in the matrix material.

The graphite in the matrix material is a non-contaminated graphite; thus, preferably, radionuclides cannot be determined therein and/or the graphite shows only natural activity. Thus, the activity of the non-contaminated graphite is preferably ≦10³ Bq/g. It is preferred, when the graphite of the matrix material is natural graphite or synthetic graphite or a mixture of both components. In this case it particularly preferred, when the proportion of graphite of the matrix mixture consists of 60% by weight to 100% by weight of natural graphite and 0% by weight to 40% by weight of synthetic graphite. The synthetic graphite may also be referred to as graphitized electrographite powder. Natural graphite has the advantages that it is well-priced, that its graphite grains are not compromised by nanocracks in contrast to grains of synthetic graphite and that it can be compressed to molded bodies having nearly theoretical density using moderate pressure.

The matrix constituents, in particular the inorganic binder and the graphite, are preferably used in the form of a powder, so that an optimum binding effect and an optimum density of the matrix material can be achieved. Preferably, the mean grain diameter of the glass powder is smaller than 100 μm, further preferably at most 50 μm and particularly preferably at most 30 μm. The glass can close optional pores between the matrix constituents more easily as the grain diameter decreases. Preferably, the graphite powder of the matrix material is also characterized by the mentioned mean grain diameters.

Also the production of the matrix material is basically known. The production of the matrix material comprises the mixing of the matrix constituents in powder form for obtaining a pressing powder. The pressing powder may comprise adjuvants in amounts of several percentages based on the total amount. These adjuvants are for example pressing adjuvants which may comprise alcohols. Preferably, from the pressing powder granules are produced. For the production of the granules the starting components, in particular the two components graphite powder and glass powder, are mixed together, then they are compacted and granules having a grain size of smaller than 3.14 mm and larger than 0.31 mm are produced by subsequent breaking and sieving.

The embedment of the molded body according to the present invention in the matrix material is preferably achieved by:
joining together at least one molded body with the matrix material to a compact, wherein preferably the matrix material is in the form of a so-called “base body” with cavities, and
final pressing of the compact for obtaining a sheathed molded body. The final pressing is preferably achieved by dynamic pressing or hot pressing, preferably under vacuum. In this case a pressing pressure of preferably between 80 MPa and 300 MPa can be used. In addition, the final pressing may comprise a step of heating up to temperatures of between 800° C. and 1400° C.

In preferable embodiments the embedment of the molded body according to the present invention in the matrix material is achieved by joining together one or more molded bodies with the matrix material which is present in the form of a “base body”. According to the present invention, a preformed geometric form which may have different designs, preferably the form of a hexagon prism, and which comprises one or more cavities for accommodating the molded body/bodies is called a base body. The molded bodies are preferably filled into the cavities. Preferably, before the final pressing the openings of the cavities are filled up with matrix material or they are covered with matrix material in the form of a further base body made of matrix material. In alternative embodiments the molded bodies are placed in matrix material which is in the form of a powder, and the mixture is subsequently compressed to a sheathed molded body by final pressing.

In embodiments in which the matrix material is already present as a base body with cavities, at first a base body with cavities, thus recesses for accommodating the molded bodies, which can easily be handled without problems is preformed. The step of preforming is, for example, conducted with the help of a four-column press with three hydraulic drives. According to the present invention, for the production of recesses preferably shaping rods which are comprised of two parts are used: a shaping rod part with a higher diameter which is connected with a thinner carrier rod.

The matrix material described herein is suitable for serving as a corrosion barrier over an ultra-long period of time. In particular, the matrix material is substantially pore-free; namely it has a density which is in the range of higher than 90% and particularly preferably >99% of the theoretical density. It is important that the matrix material is characterized by a high density so that no humidity can penetrate into the sheathed molded body. On the one hand, this is guaranteed by the selection of the material and, on the other hand, by the production process. In cooperation with the treated graphite according to the present invention the sheathed molded body can finally be disposed in a safe manner over an ultra-long period of time.

With the method for the decontamination of contaminated graphite according to the present invention a safe and ultra-long near-surface final disposal of the graphite or a final disposal at the surface depending on country-specific safety requirements becomes admissible. So the present invention facilitates a volume-saving disposal of large amounts of contaminated graphite.

A particularly preferable embodiment of the method according to the present invention is shown in FIG. 1.

### EXAMPLES

### Example 1

### Production of a Molded Body for Final Disposal

The tool consisted of two pressing cylinders and one hollow cylinder sheathing. For avoiding ‘baking on’ in the hollow cylinder a foil of graphite was placed. The bottom die was inserted and it was covered with a bottom foil of graphite. Into the pressing tool a base mixture consisting of 100 g of contaminated graphite comprising the volatile radionuclide H-3 and 20 g of glass 8800 of the company Schott (borosilicate glass) which had been prepared by mixing the components was filled. The base mixture which had been filled into the tool was covered with a foil of graphite. Subsequently, the top pressing die was inserted into the tool.

The tool was inserted into an SPS press and it was preformed with the SPS pressing die at 2 kN. At first, under a pressing pressure of 1.6 MPa an evacuation was conducted. This step was ceased after a vacuum according to the present invention had been achieved. A temperature increase according to the present invention up to an intermediate temperature of 450° C. followed. Subsequently, the pressing pressure was increased to a value of 8 MPa.

In the second phase of heating up with the method according to the present invention the temperature was increased to a target temperature of 1200° C., wherein the viscosity of the glass was <10⁵ dPa×s (heating rate: 15° C./min to 20° C./min).

During the step of heating up according to the present invention a negative temperature gradient was achieved in the base mixture, wherein ΔT was 10° C. During this step of heating up H-3 was released from the base mixture and it was reacted in a post-oxidation plant to tritiated water. The treated graphite was characterized by a considerably reduced content of volatile radionuclides. In the treated graphite the content of H-3 was reduced in an extent of 99%, based on the amount of H-3 in the contaminated graphite. The treated graphite contained all non-volatile constituents, such as e.g. Sr-90 or Co-60.

After the target temperature had been reached, the pressing pressure was increased to a value of 64 MPa in a time-dependent manner and the base mixture in the spark plasma sintering plant was compacted to a molded body with a density of >98% of the theoretical density. Subsequently, under the increased pressing pressure a step of cooling the treated graphite according to the present invention was conducted.

The obtained molded body is suitable for a safe final disposal over very long periods of time and it can in particularly be disposed in a near-surface manner or at the surface depending on country-specific regulations.

### Example 2

### Embedment of the Molded Body in a Matrix Material for Obtaining a Sheathed Molded Body

The molded body of example 1 was embedded in a matrix material consisting of non-contaminated graphite and glass. As starting components a nuclear-pure natural graphite having a grain diameter of less than 30 μm of the company Kropfmühl and a borosilicate glass having the same grain size with a melting point of about 1000° C. of the company Schott were used.

Both components were mixed under dry conditions in a weight ratio of natural graphite to glass of 5:1 and were compressed to briquettes with the help of the compactor Bepex L 200/50 P of the company Hosokawa. The density of the briquettes was about 1.9 g/cm³. By subsequent breaking and sieving granules with a grain size of smaller than 3.14 mm and larger than 0.31 mm and with a bulk density of about 1 g/cm³ were produced. Subsequently, a base body with cavities for accommodating the molded bodies of example 1 was preformed.

The molded body of example 1 was filled into the cavities and subsequently the openings of the cavities were filled up with matrix material. Subsequently, a final pressing at 1000° C. was conducted. The final pressing was conducted as a dynamic pressing. In this case the compact was moved under full load alternately with the top die and the bottom die in a mold cavity. After cooling to a temperature of 200° C. the sheathed molded body was ejected from the tool.

What is claimed is:

1. A method for the decontamination of contaminated graphite comprising the steps of:
a) heating up a base mixture comprising contaminated graphite and at least one glass for separating the volatile radionuclides from the contaminated graphite, wherein a treated graphite is obtained;
b) compacting the treated graphite for obtaining a molded body which is suitable for final disposal.

2. The method according to claim 1, wherein the molded body is embedded in the matrix material for obtaining a sheathed molded body, wherein the matrix material comprises non-contaminated graphite and at least one inorganic binder selected from glasses, aluminosilicates, silicates, borates and mixtures thereof.

3. The method according to claim 1, wherein the base mixture comprises glass in a proportion of 7% by weight to 30% by weight.

4. The method according to claim 1, wherein the glass of the base mixture is a borosilicate glass.

5. The method according to claim 1, wherein the contaminated graphite and the glass in the base mixture are each present with a mean grain diameter of less than 100 μm.

6. The method according to claim 1, wherein the base mixture further comprises oxidants.

7. The method according to claim 1, wherein the contaminated graphite comprises at least one radionuclide selected from H-3, CI-36, C-14 or mixtures thereof.

8. The method according to claim 1, wherein in the step of heating up the base mixture target temperatures of at least 800° C. and at most 1200° C. are used.

9. The method according to claim 1, wherein during the step of heating up the pressing pressure is less than 10 MPa.

10. The method according to claim 1, wherein the steps a) and b) are conducted in a hot isostatic press, hot vacuum press or spark plasma sintering plant.

11. The method according to claim 1, wherein the molded body is embedded in a matrix material and wherein the inorganic binder is contained in the matrix mixture in a proportion of 10 to 40% by weight and wherein the inorganic binder is a glass.

12. The method according to claim 2, wherein the base mixture comprises glass in a proportion of 7% by weight to 30% by weight.
